(19) United States
(12) Patent Application Publication
(10) Pub. No.: US 2015/0125568 A1
(43) Pub. Date: May 7, 2015

(54) Healthy Composition for lowering Cholesterol for use in Foods, Beverages, Health supplements and Medical Foods

(71) Applicant: Matthew James, Bear, DE (US)

(72) Inventor: Matthew James, Bear, DE (US)

(73) Assignee: Matthew James, Bear, DE (US)

(21) Appl. No.: 14/054,185

(22) Filed: Oct. 15, 2013

Related U.S. Application Data
(60) Provisional application No. 61/795,430, filed on Oct. 17, 2012.

(51) Int. Cl. A23L 1/29; A23L 1/30

(52) U.S. Cl. CPC A23L 1/296; A23L 1/3004; A23L 1/3002; A23V 2002/00
USPC 426/2; 426/615; 426/62; 426/618; 426/634; 426/578; 426/577; 426/575; 426/573; 426/590

(57) ABSTRACT

Disclosed is a composition consisting of beta-glucan (1,3), (1,4) β-D Glucan), plant sterols and a hydrocolloid. A natural way to help lower blood serum cholesterol levels to a consumer and or patient with the effective amount of disclosed composition. For use in foods, beverages, dietary supplement products and medical foods.

This application claims the benefit of priority of U.S. provisional application No. 61/795,430, filed Oct. 17, 2012, the disclosure of which is hereby incorporated by reference.

The disclosure relates to the following components, Oat Beta-Glucan (1,3), (1,4) β-D Glucan), Plant Sterols, and a Hydrocolloid which are useful in lowering blood serum cholesterol levels, and the use of them in foods, beverages, health supplements and medical foods.

It has been well established that high levels of cholesterol especially the LDL cholesterol is linked to major risk factors of cardiovascular disease. There is a large epidemic of people with elevated levels of cholesterol due to high intake of saturated fats, poor diet and lack of exercise. Therefore there is a large need to deliver healthier foods and fortified beverages that can help the ongoing battle of high cholesterol in the USA and abroad. The components 1) Oat Beta Glucan 2) Plant Sterols 3) Hydrocolloids used in this combination are preferably from natural food sources with a long history of use in foods and a safe track record to accompany. They are recognized as GRAS and two of them 1) Beta Glucan, 2) Plants Sterols have qualified health claims that are cleared by the United States Food and Drug Administration.

Back on Jan. 21^{st}, 1997, the US Food and Drug Administration (FDA) approved the printing on food-product packages of a health claim that “a diet high in soluble fiber from whole oats (oat bran, oatmeal and oat flour) and low in saturated fat and cholesterol may reduce the risk of heart disease”. In its proposal, the FDA reviewed 37 studies in which oats were consumed as hot and cold cereals or used in a variety of other foods, for example muffins, breads, shakes, and entrees. It was concluded that ≧3 g of β-glucan from oats should be consumed daily to achieve a clinically relevant decrease in serum total cholesterol concentrations. Such an amount of β-glucan is provided by ≦5 40 g oat bran or ≦60 g oatmeal. Compliance with this dietary guideline would be greatly improved if common food products rich in oats were available.
Food labeling: health claims; oats and coronary heart disease. The Food and Drug Administration, HHS. Proposed rule. Fed Regist 1996; 61:296-313.
FDA Talk Paper. FDA allows whole oat foods to make health claim on reducing the risk of heart disease. 21 Jan. 1997. Internet:http://www.cfsan.fda.gov/˜Ird/tpoats.html (accessed 27 Apr. 2001).

With the use of these components together especially in foods and beverages it allows a patient or consumer an easy way to gain the healthy cholesterol lowering benefits by blocking the absorption of cholesterol when they are consumed. When Oat Beta Glucan (1,3), (1,4) β-D Glucan) is consumed in the amount needed to have a cholesterol lowering effect it binds to bile, the cholesterol is then disposed from the body primarily from the production and the excretion of bile. Once it's been made into bile cholesterol is secreted into the small intestines, where it binds to Beta Glucan and is evacuated from the body. When fat containing foods are eaten, cholesterol and other nutrients are broken down in the stomach and transported to the small intestines. In the small intestines cholesterol in integrated into what's known as the mixed micelles.

The micelles are a group of lipid Molecules that band together allowing the body to absorb them. From our bodies point of view plant sterols look a lot like cholesterol because of this similarity the plant sterols are taken into the micelles instead of cholesterol. When plant sterols are present our bodies absorb less cholesterol. The hydrocolloid is used as an additional stabilizer and further enhances the hydrocolloid properties naturally occurring in the Beta Glucan.

The components consisting of Oat Beta Glucan (1,3), (1,4) β-D Glucan), Plant Sterols, Hydrocolloid(s) begin as a powder. The Plant Sterols is also available as a yellow viscous oily paste at ambient temperature, and above 50° C. it is a clear oil. It can be mixed together manually or mechanically in a commercial blender. All starting ingredients are water soluble and are easy to incorporate into foods, beverages, dietary supplements and or medical foods.

The foods, beverages, dietary supplements and medical foods comprise sufficient amounts of the cholesterol lowering compositions necessary to provide a reduction in blood serum cholesterol levels.

There has been an overwhelming amount of clinical evidence that oat grains and fractions containing beta glucan, which is the soluble fibre that is found in the sub-aleurone layer of the oat kernel as a cell wall component, It can lower serum cholesterol. It is because of this that the Food and Drug Administration has allowed a health claim which confirms that positive effects of consuming beta glucan soluble fibre can reduce the risk of coronary heart disease in humans. Beta-glucan is a soluble fiber derived from the cell walls of algae, bacteria, fungi, yeasts, and plants. It is commonly used for its cholesterol-lowering effects. Beta-Glucans have also been used to treat diabetes and for weight loss.

According to the European Food Safety Authority (EFSA)

“Oat Beta Glucan has been shown to lower/reduce blood cholesterol. Blood cholesterol lowering may reduce the risk of (coronary) heart disease”. web address:efsa.europa.eu/en/efsajournal/pub/1885.htm

Health Canada

“Oat Beta-Glucan helps reduce/lower cholesterol, (which is) a risk facto for heart disease.” web hc-sc.qc.ca/fn-an/label-etiquet/claims-reclam/assess-evalu/oat-avoine-eng.php

The Oat Beta-Glucan (1,3), (1,4) β-D Glucan can be present in the composition in amount ranging from about 0.51% to about 72%, for example from about 0.51% to about 72%, as a further example from about 0.51% to about 86%.

Oat Beta-Glucan (more correctly and systematically: (1,3), (1,4) β-D Glucan) is a substance found naturally in several foods, including oats, barley, and certain mushrooms. Also found in yeasts, beta-glucan is classified as a polysaccharide. The term beta-glucan can be selected from a single source and or a combination of sources consisting of Amylodextrins, baker's yeast, barley, beta-glucans, beta glycans, beta-glycans, d-fraction, GD, grifolan, griton-d(r), GRN, lentinan, maitake mushroom, PGG glucan, PGG-glucan, oat beta-glucan, oat fiber, oat fibre, oat gum, Plantago major L., poria cocos sclerotium, Saccharomyces cerevisiae, schizophyllan (SPG), Sparassis crispa, SSG, yeast-derived beta glucan.

(1) Cardiovascular disease means diseases of the heart and circulatory system. Coronary heart disease (CHD) is one of the most common and serious forms of cardiovascular disease and refers to diseases of the heart muscle and supporting blood vessels. High blood total cholesterol and low density lipoprotein (LDL) cholesterol levels are associated with increased risk of developing coronary heart disease. High CHD rates occur among people with high total cholesterol levels of 240 milligrams per deciliter (mg/dL) (6.21 millimole per liter (mmol/l)) or above and LDL cholesterol levels of 160 mg/dL (4.13 mmol/l) or above. Borderline high risk blood cholesterol levels range from 200 to 239 mg/dL (5.17 to 6.18 mmol/l) for total cholesterol, and 130 to 159 mg/dL (3.36 to 4.11 mmol/l) of LDL cholesterol. (2) Populations with a low incidence of CHD tend to have relatively low blood total cholesterol and LDL cholesterol levels. These populations also tend to have dietary patterns that are not only low in total fat, especially saturated fat and cholesterol, but are also relatively high in plant foods that contain dietary fiber and other components. 3) Scientific evidence demonstrates that diets that include plant sterol/stanol esters may reduce the risk of CHD.

web-accessdata.fda.gov/scripts/cdrh/cfdocs/cfcfr/CFRSearch.cfm?fr=101.83

Health Canada has concluded that acceptable scientific evidence exists in support of the claim about the relationship between the consumption of plant sterol-enriched foods as foods and blood cholesterol lowering. Consumption of these foods results in the lowering of total blood cholesterol as well as LDL-cholesterol levels, while having no detrimental effect on HDL-cholesterol levels, resulting in overall improvements in the blood lipid profile.

### “Plant Sterols Help Reduce [or Help Lower] Cholesterol.”

web address hc-sc.gc.cafin-an/label-etiouet/claims-reclam/assess-evalu/phvtosterols-eng.php

According to the European Food Safety Authority (EFSA) “Plant sterols have been shown to lower/reduce blood cholesterol. Blood cholesterol lowering may reduce the risk of (coronary) heart disease”.

web efsa.europa.eu/en/efsajournal/doc/nda_op_ei781_art14_{—}004_plant sterols-and_blood_cholesterol.pdf?ssbinarv=true

The term “Plant Sterols” used in the composition includes, without limitation, phytosterols, phytosetrol esters, phytostanol and phytostanol esters.

Any Sterol can be utilized in the composition herein that are acceptable for lowering blood serum cholesterol levels. The term Sterol includes and is not limited to any sterol, any stanol, and mixtures thereof; it also includes and is not limited to esters of sterols, esters of stanols and mixtures thereof. The esters can also be carboxylic acid esters such as fatty acid esters. The sterol can be any sterol that is obtained from a vegetable, soybean, tree and mixtures thereof.

The Plant Sterols for use herein the disclosed composition may include any various isomer and stereoisomeric forms, such as α-, β-, or γ-isomers. The typical phytosterol compounds would include α-sitosterol, γ-sitosterol, β-sitosterol, campesterol, stigmasterol, brassicasterol, spinosterol, taraxasterol, desmosterol, chalinosterol, poriferasterol, clionasterol, ergosterol, Δ-5 avenosterol, Δ-5-campesterol, clerosterol, Δ-5-stigmasterol, Δ-7, 25-stigmadienol, Δ-7-avenosterol, Δ-7-β-sitosterol, and Δ-7-brassicasterol.

Beneficial phytostanol compounds include α-, β-, and γ-sitostanol, campestanol, stigmastanol, spinostanol, taraxastanol, brassicastanol, desmostanol, chalinostanol, poriferastanol, clionastanol, and ergostanol.

The following are examples of phytosterol esters which are include, without limitation, β-sitosterol laurate ester, α-sitosterol laurate ester, γ-sitosterol laurate ester, campesterol myristearate ester, stigmasterol oleate ester, campesterol stearate ester, β-sitosterol oleate ester, β-sitosterol palmitate ester, β-sitosterol linoleate ester, a-sitosterol oleate ester, γ-sitosterol oleate ester, β-sitosterol myristearate ester, β-sitosterol ricinoleate ester, campesterol laurate ester, campesterol ricinoleate ester, campesterol oleate ester, campesterol linoleate ester, stigmasterol linoleate ester, stigmasterol laurate ester, stigmasterol caproate ester, α-sitosterol stearate ester, γ-sitosterol stearate ester, α-sitosterol myristearate ester, γ-sitosterol palmitate ester, cam pesterol ricinoleate ester, stigmasterol ricinoleate ester, campesterol ricinoleate ester and stigmasterol stearate ester.

Phytostanoi esters for inclusion provided within include, without limitation β-sitostanol laurate ester, campestanol myristearate ester, stigmastanol oleate ester, campestanol stearate ester, β-sitostanol oleate ester, β-sitostanol palmitate ester, β-sitostanol linoleate ester, β-sitostanol myristearate ester, β-sitostanol ricinoleate ester, campestanol laurate ester, campestanol ricinoleate ester, campestanol oleate ester, campestanol linoleate ester, stigmastanol linoleate ester, stigmastanol laurate ester, stigmastanol caproate ester, stigmastanol stearate ester, -α-sitostanol laurate ester, γ-sitosterol laurate ester, α-sitostanol oleate ester, γ-sitosterol oleate ester, α-sitostanol stearate ester, γ-sitosterol stearate ester, α-sitostanol myristearate ester, γ-sitosterol palmitate ester, campestanol ricinoleate ester, stigmastanol ricinoleate ester, campestanol ricinoleate ester, β-sitostanol, α-sitostanol, γ-sitosterol, campestanol, and stigmastanol.

Steryl esters are suitable for use within include composition and are not limited to, fatty acid esters of plant phytosterols such as: sitosterol, campesterol, stigmasterol, brassicasterol, avenasterols, and diosgenin, or mixtures thereof. The sterol esters also include the esterified and hydrogenated forms of sterols such as sitostanol and campestanol, and the like, ferulate esters, or succinate esters.

The Plant Sterols can be present in the composition in an amount ranging from about 0.1% to about 84%, for example from about 0.1% to about 91%, as a further example from about 0.1% to about 95% by weight relative to the total weight of the composition.

The Hydrocolloid(s) keeps the Oat Beta Glucan (1,3), (1,4) and Plant Sterols from settling to the bottom of a container. Without the presents of the hydrocolloid the down side would be separation and or possible loss of the beneficial components needed to have the optimal effect. The Hydrocolloid(s) enhances mouth feel, provides food(s) and beverages with a more desirable look, creates a richer creamier taste while improving the over all flavor profile.

The Hydrocolloid(s) can be present in the composition in an amount ranging from about 0.114% to about 0.475% by weight relative to the total weight of composition.

The Webster's definition of a Hydrocolloid—a substance that yields a gel with water. In the composition at least 1 hydrcolloid is present and is not limited to a Carrageenan, Guar Gum, Xanthum Gum. Gellan Gum, Gum Arabica, Tara Gum, Locust Bean Gum, Tapioca Starch, Modified Food Starch, Corn Starch, Citrus Fiber, Modified Food Starch, Rice Flour, Potato, Starch, Konjac, Pectin, Oat Gum, Alginates, Gum tragacanth, Furcellaran, Gelatin, Starch.

When disclosed composition is added to skim and or low fat 1% milk it creates—replicates the taste and flavor of a whole milk. This offers a great benefit and alternative to whole milk(s) by reducing the amount of fat and calories that could otherwise be consumed by a child or adult.

The benefit is further paid forward by delivering the fortified ingredients in the disclosed composition that also provides a cholesterol lowering effect on blood serum cholesterol.

Food and beverage products containing the blood serum cholesterol lowering composition may be incorporated Into and is not limited to bakery items such as bagels, rolls, breads, cakes, muffins, icings, waffles, pancakes, biscuits, cupcakes, cookies, crackers, cereal products, pastas, enriched flours, snacks, cream alcoholic and non alcoholic drinks, juices, smoothies and purees, freeze dried juices and juice sticks, ices, dairy and non dairy milk products, desserts, yogurt, frozen yogurts, sherbets, cheeses, spreads, dressings, ready mix salad dressings, batter and filling for meat products, egg products, oil emulsions, mayonnaise and the like.

A list of other suitable examples of foods, beverages, dietary supplements and for medical foods. Supplement Powders, Mini Chews, and other types of Confections Juices and Ready to Drink Juices, not limited to purees, concentrates, dehydrated or freeze-dried. Milk Powders, Milk, (Dairy, Soy, Coconut, Rice, Hemp, Oat, Safflower Milks, Almond, Cashew) and milk based beverages. Instant Protein Smoothies, Shakes and Meal Replacements. Ready to Drink Smoothies, Shakes, Meal Replacements. Protein Bars, Nutrition Bars, (cold extrusion) Baked Bars with or without filled fruit fillings, Cookies, Muffins, Breads, Pancakes, Hot Cereals and ready to eat Extruded Cereals Nano Liquid Shots and Gel Shots Soups, ready to eat, instant soups, condensed, Frozen Yogurts and Ice creams (Dairy and Soy, Coconut, Rice, Hemp, Oat, Safflower Milks, Almond, Cashew).Puddings, Custards, Cheeses and Spreads, Rice and Tapioca Puddings, Yogurt (Dairy & Soy) Gel Capsules, Tablets, Gummy Bears Sauces and Edible Coatings, Mousses, Sherbets and Ices.

Beta-Glucan—FDA approved claims—

Soluble Fiber from Certain Foods and Risk of Coronary Heart Disease

### (21 CFR 101.81)

Low saturated fat
Low cholesterol
Low fat, and

The food product must include one or more of the following whole oat or barley foods: 1) oat bran, 2) rolled oats, 3) whole oat flour, 4) whole grain barley or dry milled barley, and the whole oat or barley foods must contain at least 0.75 g of soluble fiber per RACC of the food product; or

Oatrim that contains at least 0.75 g of beta-glucan soluble per RACC of the food product; or

Psyllium husk that contains at least 1.7 g of soluble fiber per RACC of food product.

### Eligible Sources of Soluble Fiber

Beta-glucan soluble fiber from the following whole oat and barley sources:

1) Oat bran

2) Rolled Oats

3) Whole Oat Flour

4) Oatrim

5) Whole Grain Barley and Dry Milled Barley

6) Barley Beta Fiber

7) Soluble fiber from psyllium husk with purity of no less than 95%

The amount of soluble fiber per RACC must be declared in nutrition label.

### Required Terms:

“Heart disease” or “coronary heart disease.”
“Saturated fat” and “cholesterol.”

In specifying the substance the claim uses the term “soluble fiber” qualified by the name of the eligible source of the soluble fiber, which is either whole oat or barley or psyllium seed husk.

Claim specifies the daily dietary intake of the soluble fiber source necessary to reduce the risk of CHD

Claim specifies the amount of soluble fiber in one serving of the product.

### Additional Required Label Statement

Foods bearing a psyllium seed husk health claim must also bear a label statement concerning the need to consume them with adequate amounts of fluids; e.g., “NOTICE: This food should be eaten with at least a full glass of liquid. Eating this product without enough liquid may cause choking. Do not eat this product if your have difficulty in swallowing.”

### (21 CFR 101.17(t)).

Soluble fiber from foods such as [name of soluble fiber source, and, if desired, name of food product], as part of a diet low in saturated fat and cholesterol, may reduce the risk of heart disease. A serving of [name of food product] supplies_grams of the [necessary daily dietary intake for the benefit] soluble fiber from [name of soluble fiber source] necessary per day to have this effect.

web/.fda.gov/Food/GuidanceRegulation/GuidanceDocumentsRegulatoryInformation/LabelingNutrition/ucm064919.htm

### Plants Sterols—FDA Approved Claims Below

Plant sterol/stanol esters and Rick of Coronary Heart Disease (21 CFR 101.83) At least 0.65 g plant sterol esters per RACC of spreads and salad dressings, or At least 1.7 g Plant stanol esters per RACC of spreads, salad dressings, snack bars, and dietary supplements. Low saturated fat, Low cholesterol, and Spreads and salad dressings that exceed 13 g fat per

50 g must bear the statement “see nutrition information for fat content” Salad dressings are exempted from the minimum 10% DV nutrient requirement (see General Criteria below)

### Required Terms:

“May” or “might” reduce the risk of CHD

“Heart disease” or “coronary heart disease”

“Plant sterol esters” or “plant stanol esters”; except “vegetable oil” may replace the term “plant” if vegetable oil is the sole source of the sterol/stanol ester

Claim specifies plant stero/stanol esters are part of a diet low in saturated fat and cholesterol.

Claim does not attribute any degree of CHD risk reduction.

Claim specifies the daily dietary intake of plant sterol or stanol esters necessary to reduce CHD risk, and the amount provided per serving.

Claim specifies that plant sterol or stanol esters should be consumed with two different meals each a day.

(1) Foods containing at least 0.65 gram per of vegetable oil sterol esters, eaten twice a day with meals for a daily total intake of least 1.3 grams, as part of a diet low in saturated fat and cholesterol, may reduce the risk of heart disease. A serving of [name of food] supplies_grams of vegetable oil sterol esters.
(2) Diets low in saturated fat and cholesterol that include two servings of foods that provide a daily total of at least 3.4 grams of plant stanol esters in two meals may reduce the risk of heart disease. A serving of [name of food] supplies_grams of plant stanol esters.
fda.gov/Food/GuidanceRegulation/GuidanceDocumentsRequlaton/Information/LabelingNutrition/ucm064919 dot htm

Table one demonstrates the use of the composition in a flavored low fat milk base in detail, and the process for producing the heart health low fat 1% milk beverage are as follows:

TABLE 1

| Ingredient | % |
|---|---|
| 1% Milk | 98.3666 |
| Oat Beta Glucan | 0.5169 |
| (1,3 1,4) 40% | |
| Sugar | 0.5000 |
| Stevia Reb-A 98% | 0.0125 |
| Erythritol | 0.0521 |
| Beet Powder | 0.0300 |
| Cherry Flavor | 0.1750 |
| Plant Sterol 40% | 0.3019 |
| Gellan Gum | 0.0450 |
| Total | 100.00 |

Premix the dry ingredients, combine with cool milk and hydrate for at least 10 minutes HTST process 185° F. for 30 SEC, 145° F. homogenize 500 PSIG 2^{ND} stage only Use coolers to collect at 130-140° F.

Use ice bath with agitation to decrease temperature to 75-80° F.
Fill in containers and store under refrigeration.

Table two demonstrates the use of the composition in a Non flavored low fat milk base in detail, and the process for producing the heart health low fat milk beverage are as follows:

| Ingredient | % |
|---|---|
| Skim Milk | 72.6753 |
| Whole Milk | 25.8530 |
| Oat Beta Glucan | 0.5095 |
| (1,3 1,4) 40% | |
| Sugar | 0.5000 |
| Stevia Reb-A 98% | 0.0125 |
| Erythritol | 0.0521 |
| Plant-Sterols | 0.2976 |
| minimum 40% | |
| Carrageenan | 0.1000 |
| Total | 100.00 |

Premix the dry ingredients, combine with cool milk and hydrate for at least 10 minutes HTST process 185° F. for 30 SEC, 145° F. homogenize 500 PSIG 2^{ND} stage only Use coolers to collect at 130-140° F. Use ice bath with agitation to decrease temperature to 75-80° F. Package containers and store under refrigeration.

The above tables and specifications are provided as examples and should be considered as exemplary only, a true understanding and essence of the invention being indicated by the following claims.

1. A composition comprising: of A) Oat Beta Glucan (1,3), (1,4) β-D Glucan) and or from an alternative source of Beta Glucan (1,3), (1,4), B) Plant Sterol C) Hydrocolloid, for use in Food, Beverage, Medical Foods, Dietary Supplements to support healthy cholesterol levels in the body.

2. The composition of claim 1, wherein one Beta-Glucan is selected from the group consisting of Amylodextrins, Baker's Yeast, Barley, Beta-Glucans, Beta Glycans, Beta-Glycans, d-fraction, GD, grifolan, griton-d(r), GRN, Lentinan, Maitake Mushroom, PGG Glucan, PGG-glucan, Oat Beta-Glucan, Oat Fiber, Oat Fibre, Oat Gum, Plantago major L., Poria Cocos Sclerotium, Saccharomyces Cerevisiae, Schizophyllan (SPG), Sparassis Crispa, SSG, Yeast-derived Beta Glucan.

3. The composition of claim 1, wherein the Beta Glucan is a Oat Kernel extract: Beta Glucan Fibres and Amylodextrins from the Oat Bran.

4. The composition of claim 1, wherein the Beta Glucan is selected from the group consisting of Oat Beta Glucan (1,3), (1,4) β-D Glucan), and or mixtures thereof.

5. The composition of claim 1, wherein the sterol is selected from the group consisting of Phytosterols, Phytosterol Esters, Phytostanols, Phytostanol Esters, and mixtures thereof.

6. The composition of claim 1, wherein the sterol is a Sterol obtained from a Vegetable, a Soybean, a Tree, or mixtures thereof.

7. The composition of claim 1, wherein at least one of the compound are present in the amounts sufficient to lower blood serum cholesterol levels.

8. The composition of claim 1, wherein the Beta-Glucan is present in an amount ranging from about 0.51% to about 42.8% by weight relative to the total weight of the composition.

9. The composition of claim 1, wherein the Plant Sterol is present in an amount ranging from about 0.1% to about 84% by weight relative to the total weight of the composition.

10. The composition of claim 1, wherein a Hydrocolloid is present in an amount ranging from about 0.114% to about 0.475% by weight relative to the total weight of composition.

11. The composition of claim 1, wherein at least one Hydrocolloid is selected from the various Hydrocolloids Carrageenan, Guar Gum, Xanthum Gum. Gellan Gum, Gum Arabica, Tara Gum, Locust Bean Gum, Tapioca Starch, Modified Food Starch, Corn Starch, Citrus Fiber, Modified Food Starch, Rice Flour, Potato, Starch, Konjac, Pectin, Oat Gum, Alginates, Gum tragacanth, Furcellaran, Gelatin, Starch.

12. The composition of claim 1, wherein the Beta Glucan (1,3), (1,4), Plant Sterol and Hydrocolloid is present in amount ranging from 0.852% to about 71.6% by weight relative to the total
weight of the composition.

13. The Composition of claim 1, wherein the Beta Glucan (1,3), (1,4) is present in amount ranging from about 0.51% to about 72% by weight relative to the total weight of the composition.

14. The composition of claim 1, in which the Beta Glucan (1,3), (1,4) is present in amount ranging from about 0.51% to about 86% by weight relative to the total weight of the composition.

15. The composition of claim 1, wherein the Sterol is present in an amount ranging from about 0.1% to about 91% by weight relative to the total weight of the composition.

16. The composition of claim 1, wherein the Sterol is present in an amount ranging from about 0.1% to about 95% by weight relative to the total weight of the composition.

17. The composition of claim 1, wherein the composition comprises the Beta Glucan (1,3), (1,4), Plant Sterol.

18. The composition of claim 1, wherein the composition comprises the Beta Glucan (1,3), (1,4), Plant Sterol, Hydrocolloid.

19. A food or beverage or health supplement product comprising:
a composition comprising:
at least one of a compound selected from the group consisting of a Beta Glucan (1,3), (1,4), Plant Sterol and a Hydrocolloid.

20. A method of lowering blood serum cholesterol levels comprising administering to a patient in need thereof an effective amount of a composition comprising:
at least one of a compound selected from the group consisting of an Beta Glucan (1,3), (1,4)-, Plant Sterol and a Hydrocolloid.
